(19) United States
(12) Patent Application Publication
(10) Pub. No.: US 2007/0250533 A1
(43) Pub. Date: Oct. 25, 2007

(54) Method, Apparatus, System, and Computer Program Product for Generating or Updating a Metadata of a Multimedia File

(76) Inventor: Wei-Hung Huang, Hsinchu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/379,517

(22) Filed: Apr. 20, 2006

(51) Int. Cl. G06F 17/00

(52) U.S. Cl. 707/104.1

(57) ABSTRACT

A system, an apparatus, a method, and a computer program product for generating and/or updating a metadata of a multimedia file are provided. The system comprises a storage device for storing the multimedia file and the apparatus. The apparatus comprises an extraction unit for extracting storage information of the multimedia file, an analysis unit for analyzing the storage information, and a metadata generator for generating the metadata according to an analyzing result. The method comprises the steps of: extracting storage information of the multimedia file; analyzing the storage information; and generating the metadata according to an analyzing result. The computer program product stores a computer program to execute the method.

### CROSS-REFERENCES TO RELATED APPLICATIONS

Not applicable.

### BACKGROUND OF THE INVENTION

1. Field of the Invention

The present invention relates to a method, an apparatus, a system, and a computer program product for generating or updating a metadata of a multimedia file; in particular, relates to a method, an apparatus, a system and a computer program product for generating or updating a metadata of a multimedia file according to the storage information of the multimedia file.

2. Descriptions of the Related Art

Due to the rapid development of multimedia technologies, people like to use multimedia files in their daily life. Companies also prefer to use multimedia files to introduce their products as well. The tendency leads to huge amount of usage of multimedia files which are carried in CD-ROMs, hard disks, removable disks, databases, or the like. However, indexing and annotating multimedia files have been recognized as a difficult problem. Without proper indexing and annotation, people may have to check all the stored files and take looks into them in order to find out just one desired multimedia file.

Metadata of multimedia files are adapted to solve the aforementioned problem. They provide summary-like information of the multimedia files, including a title, a date, an artist an attribute, and an event etc. Many popular media formats of multimedia files are designed to embed such information. For example, a MP3 file comprises an ID3v2 tag to indicate what the MP3 file is. The advantage of embedding a metadata in a multimedia file is that the content of the multimedia file can easily be searched and understood without opening the multimedia file. In addition to audio files such as MP3 files, video files, image files, and even texture files comprise embedded metadata as well.

Nevertheless, the items of a metadata are inputted manually. That is, they cannot be generated or updated when the information of a multimedia file are added or revised. Consequently, how to generate or update suitable metadata for various types of multimedia files without manual inputs is a critical problem.

### SUMMARY OF THE INVENTION

An object of this invention is to provide a method for generating a metadata embedded in a multimedia file. The method comprises the steps of: extracting storage information of the multimedia file; analyzing the storage information; and generating the metadata according to an analyzing result.

Another object of this invention is to provide a method for generating a metadata for a multimedia file. The method comprises the steps of: extracting storage information of the multimedia file; analyzing the storage information; and generating the metadata according to an analyzing result, wherein the metadata is stored in a database.

Another object of this invention is to provide a method for updating a metadata of a multimedia file. The method comprises the steps of: extracting storage information of the multimedia file; analyzing the storage information; and updating the metadata according to an analyzing result.

Another object of this invention is to provide a computer program product for storing a computer program to execute a method for generating a metadata embedded in a multimedia file. The computer program comprises: code for extracting storage information of the multimedia file; code for analyzing the storage information; and code for generating the metadata according to an analyzing result.

Another object of this invention is to provide an apparatus for generating a metadata embedded in a multimedia file. The apparatus comprises: an extraction unit for extracting storage information of the multimedia file; an analysis unit for analyzing the storage information; and a metadata generator for generating the metadata according to an analyzing result.

Another object of this invention is to provide an apparatus for generating a metadata for a multimedia file. The apparatus comprises: an extraction unit for extracting storage information of the multimedia file; an analysis unit for analyzing the storage information; and a metadata generator for generating the metadata according to an analyzing result wherein the metadata is stored in a database.

Another object of this invention is to provide an apparatus for updating a metadata of a multimedia file. The apparatus comprises: an extraction unit for extracting storage information of the multimedia file; an analysis unit for analyzing the storage information; and a metadata generator for updating the metadata according to an analyzing result.

A further object of this invention is to provide a system for generating a metadata embedded in a multimedia file. The system comprises: a storage device for storing the multimedia file and a processing unit for extracting storage information of the multimedia file from the storage device, analyzing the storage information, and generating the metadata according to an analyzing result wherein the metadata is stored in the storage device.

A further object of this invention is to provide a system for generating a metadata for a multimedia file. The system comprises: a storage device for storing the multimedia file; a processing unit for extracting storage information of the multimedia file from the storage device, analyzing the storage information, and generating the metadata according to analyzing result; and a database for storing the metadata.

A further object of this invention is to provide a system for updating a metadata of a multimedia file. The system comprises: a storage device for storing the metadata and the multimedia file; and a processing unit for extracting storage information of the multimedia file from the storage device, analyzing the storage information, and generating a new metadata according to an analyzing result, wherein the metadata is overwritten with the new metadata.

Yet a further object of this invention is to provide an apparatus for generating a metadata embedded in a multimedia file. The apparatus comprises: means for extracting storage information of the multimedia file; means for analyzing the storage information; and means for generating the metadata according to an analyzing result.

Yet a further object of this invention is to provide an apparatus for generating a metadata for a multimedia file. The apparatus comprises: means for extracting storage information of the multimedia file; means for analyzing the storage information; and means for generating the metadata according to an analyzing result wherein the metadata is stored in a database.

Yet a further object of this invention is to provide an apparatus for updating a metadata of a multimedia file. The apparatus comprises: means for extracting storage information of the multimedia file; means for analyzing the storage information; and means for updating the metadata according to an analyzing result.

The present invention is capable of generating and/or updating a metadata for a multimedia file based on data structure of the multimedia file. The items of the metadata are hence unnecessary to be inputted manually.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A illustrates an example of a data structure;

FIG. 1B illustrates another example of the data structure;

FIG. 2 illustrates a first embodiment of this invention;

FIG. 3 illustrates a second embodiment of this invention;

FIG. 4 illustrates an example of the data structure having a plurality of WMV files;

FIG. 5 illustrates a fourth embodiment of this invention;

FIG. 6 illustrates a sixth embodiment of this invention;

FIG. 7 illustrates a tenth embodiment of this invention; and

FIG. 8 illustrates an eleventh embodiment of this invention.

### DESCRIPTION OF THE PREFERRED EMBODIMENT

This invention provides various apparatuses, methods, computer program products, and systems to generate or update a metadata of a multimedia file according to its storage information. The derived metadata may be embedded in the multimedia file itself and/or be stored in a database. It is noted that the multimedia file at least comprises one of an audio, an image, a texture, and a video file, or their combination.

The storage in a storage device of the multimedia file is arranged in a particular data structure. The particular data structure is generated based on a rule made by users and, generally speaking, such a data structure provides storage information which reveals some information of the multimedia files, such as a date, an artist, an album, an attribute, and/or a title thereof. The present invention utilizes the storage information to generate or update a metadata.

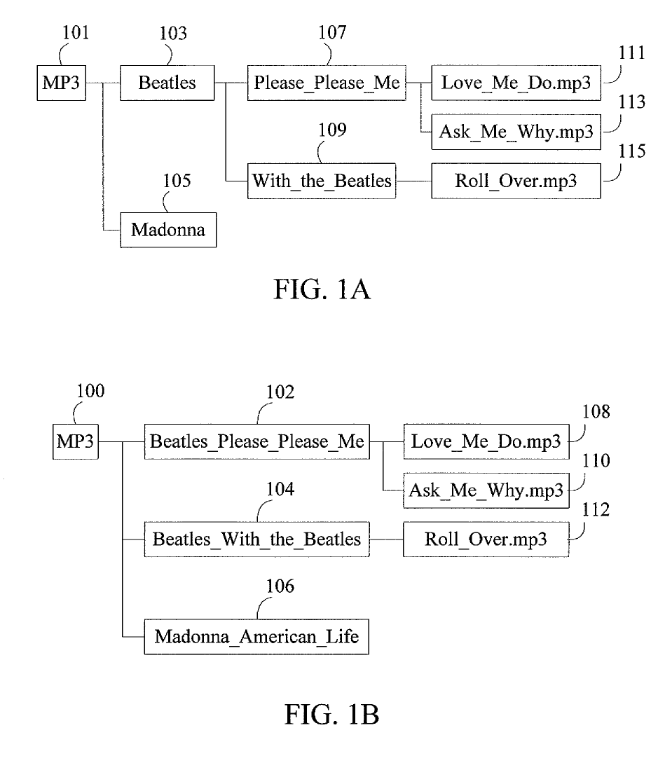

FIG. 1A shows an example of a data structure having a plurality of multimedia files stored in a removable disk which may be recognized by a Microsoft Windows operating system or a UNIX operating system. The root directory is named MP3 101, which a user uses to store MP3 files. The root directory MP3 101 comprises two sub-directories, Beatles 103 and Madonna 105, to indicate two singers. Further, the directory Beatles 103 comprises two sub-directories, Please_Please_Me 107 and With_the_Beatles 109, to indicate two album titles of Beatles. Under the directory Please_Please_Me 107 are two MP3 files: Love_Me_Do.mp3 111 and Ask_Me_Why.mp3 113, which are two of the songs in the album “Please Please Me.” Under the directory With_the_Beatles 109 is an MP3 file: Roll_Over.mp3 115, which is one of the songs in the album “With the Beatles.” Apparently, the data structure comprises the information of singers, albums, and titles of the MP3 files.

FIG. 1B shows another example of the data structure. The root directory MP3 100 comprises three sub-directories: Beatles_Please_Please_Me 102, Beatles_with_the_Beatles 104, and Madonna American_Life 106. Each of the three directory names comprises a singer name and an album title. Further, the directory Beatles_Please_Please_Me 102 comprises two MP3 files: Love_Me Do.mp3 108 and Ask_Me_Why.mp3 110, which are two of the songs in the album “Please Please Me” of the Beatles. Similarly, since Roll_Over.mp3 112 is one of the songs in the album “With the Beatles” of the Beatles, it is stored in the directory Beatles_With_the_Beatles 104. The data structure also comprises the information of singers, albums, and titles of the MP3 files.

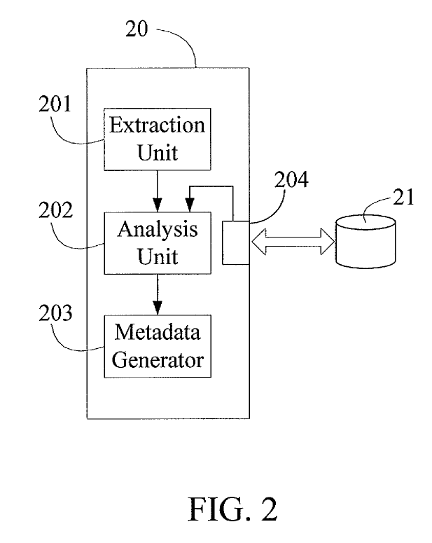

A first embodiment of this invention is illustrated in FIG. 2, which is an apparatus 20 for generating an ID3v2, i.e., a metadata embedded in a MP3 file. The apparatus 20 comprises an extraction unit 201, an analysis unit 202, a metadata generator 203, and a first interface 204. The extraction unit 201 is configured to extract storage information of the mp3 file. The analysis unit 202 is configured to analyze the storage information. The metadata generator 203 is configured to generate the ID3v2 according to an analyzing result. The first interface 204 is connected to a database 21, wherein the database 21 comprises external information associated with the MP3 file.

The file Love_Me_Do.mp3 111 illustrated in FIG. 1A is used to demonstrate how this embodiment works. The extraction unit 201 is used to extract storage information of Love_Me_Do.mp3 111. The storage information comprises the directory names from the root directory to the subdirectory and the file name itself. Thus, the extraction unit 201 extracts “MP3,” “Beatles,” “Please_Please_Me,” and “Love_Me_Do” out. The analysis unit 202 then analyzes the extracted directory and file names derived from the extraction unit 201.

The database 21 is configured to provide the external information associated with the Love_Me Do.mp3 111 through the interface 204. More particularly, the external information helps the analysis unit 202 to analyze the storage information. By reference to the external information in the database 21, the analysis unit 202 parses the storage information and realizes that the information corresponds to a file format a singer name, an album title, and a song title, respectively. In other words, the analysis unit 202 derives an analyzing result that the Love_Me Do.mp3 111 is an audio file in mp3 format “Beatles” is the singer name of Love_Me_Do.mp3, “Please Please Me” is the album title of Love_Me_Do.mp3, and “Love Me Do” is the song title of Love_Me_Do.mp3.

The metadata generator 203 receives the analyzing result to generate and embed the ID3v2 to the MP3 file. The ID3v2 comprises several columns that carry different information of the MP3 files. The metadata generator 203 saves each item of the analyzing result to an appropriate column. For example, “Beatles” is saved to the column of the singer name, “Please Please Me” is saved to the column of the album title, and “Love Me Do” is saved to the column of the song title. The metadata generator 203 may generate the ID3v2 automatically or when receiving an instruction.

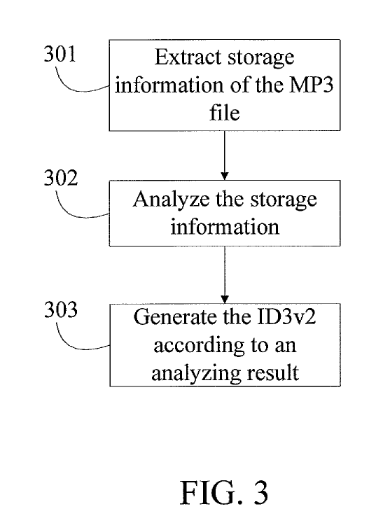

A second embodiment of this invention is illustrated in FIG. 3, which is a method for generating an ID3v2 embedded in an MP3 file as described in the first embodiment. The method first executes step 301 to extract storage information of the MP3 file. The storage information comprises directory names and/or file names. Then the method executes step 302 to analyze the storage information by parsing the directory names and/or the file names. Finally, the method executes step 303 to generate the ID3v2 according to an analyzing result. In addition to the steps shown in FIG. 3, the second embodiment may perform all of the operations or functions recited in the first embodiment.

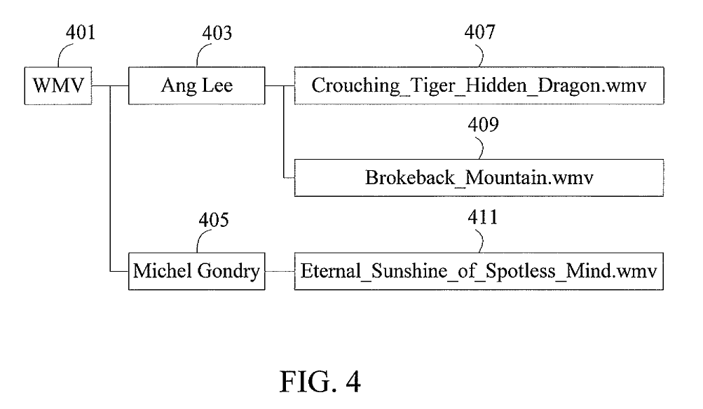

A third embodiment of this invention is the apparatus, shown in FIG. 2, for generating a metadata embedded in a WMV file. The metadata comprises columns of a producer, a director, an attribute, and a publication year, etc. An example of the data structure having a plurality of WMV files stored in an optical disc which may be recognized by a Microsoft Windows operating system or a UNIX operating system is illustrated in FIG. 4. In FIG. 4, the root is WMV 401, which comprises two sub-directories: Ang_Lee 403 and Michel_Gondry 405. The directory Ang_Lee 403 comprises two WMV files: Crouching_Tiger_Hidden_Dragon.wmv 407 and Brokeback_Mountain.wmv 409. The directory Michel_Gondry 405 comprises a file Eternal_Sunshine_of_Spotless_Mind.wmv 411.

When generating a metadata embedded in Crouching_Tiger_Hidden_Dragon.wmv 407, the extraction unit 201 extracts “WMV,” “Ang Lee,” and “Crouching_Tiger_Hidden_Dragon” out. The analysis unit 202 then analyzes the extracted directory and file names derived from the extraction unit 201. By reference to the external information in the database 21, the analysis unit 202 parses the information and realizes that the information corresponds to a file format, a director, and a movie title, respectively. In other words, the analysis unit 202 derives an analyzing result that the Crouching_Tiger_Hidden_Dragon.wmv 407 is a movie file in a WMV format, “Ang Lee” is the director of Crouching_Tiger_Hidden_Dragon.wmv 407 and “Crouching Tiger Hidden Dragon” is the title of Crouching_Tiger_Hidden_Dragon.wmv 407. The metadta generator 203 saves the items of the analyzing result to an appropriate column of the metadata For example, “Ang Lee” is saved to the column of the director, and “Crouching_Tiger_Hidden_Dragon” is saved to the column of the movie title. Similarly, the metadata generator 203 may generate the metadata automatically or when receiving an instruction.

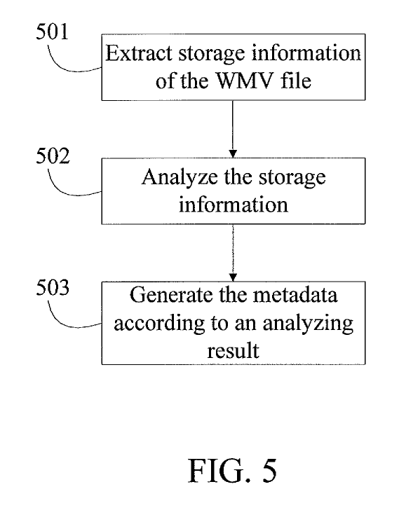

A fourth embodiment of this invention is illustrated in FIG. 5, which is a method for generating a metadata embedded in a WMV file as described in the third embodiment. The method first executes step 501 to extract storage information of the WMV file. The storage information comprises directory names and/or file names. Then, the method executes step 502 to analyze the storage information by parsing the directory names and/or the file names. Finally, the method executes step 503 to generate the metadata according to an analyzing result. In addition to the steps shown in FIG. 5, the fourth embodiment may perform all of the operations or functions recited in the first embodiment.

A fifth embodiment of this invention is the apparatus, shown in FIG. 2, for updating a metadata for an image file in a JPEG format. The metadata already exists and is stored either in a header of the JPEG file or in a database such as a hard disc. The extraction unit 201 extracts storage information of the JPEG file. By reference to the external information in the database 21, the analysis unit 202 parses the storage information. The metadata generator 203 updates the content of the metadata according to an analyzing result. The metadata generator 203 may update the metadata automatically or when receiving an instruction.

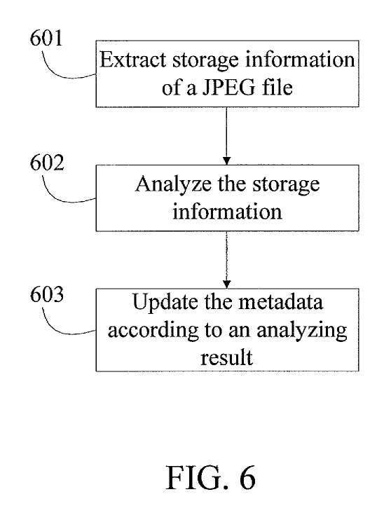

A sixth embodiment of this invention is illustrated in FIG. 6, which is a method for updating a metadata embedded in a JPEG file as described in the fifth embodiment. The method first executes step 601 to extract storage information of the JPEG file. The storage information comprises directory names and/or file names. Then, the method executes step 602 to analyze the storage information by parsing the directory names and/or the file names. Finally, the method executes step 603 to update the metadata according to an analyzing result. In addition to the steps shown in FIG. 6, the sixth embodiment may perform all of the operations or functions recited in the first embodiment.

A seventh embodiment of this invention is an apparatus for generating a metadata of a multimedia file stored in a database. In contract to the first embodiment the seventh embodiment further comprises an interface, other than the interface 204, connected to a database other than the database 21. After the metadata generator 203 generates the metadata, the metadata is stored in the database other than the database 21 but not embedded in the multimedia file.

An eighth embodiment of this invention is a method for generating a metadata of a multimedia file. The flow chart of the method is similar to the one shown in FIG. 5. Furthermore, the eighth embodiment comprises a step of storing the metadata in a database instead of embedding the metadata to the multimedia file. In addition to the steps shown in FIG. 5, the eighth embodiment may perform all of the operations or functions recited in the first embodiment.

A ninth embodiment of this invention is a computer program product for storing a computer program to execute a method for generating a metadata, e.g., the method in the second embodiment. The computer program comprises code for extracting storage information of the multimedia file, code for analyzing the storage information, code for accessing to a database, and code for generating the metadata according to an analyzing result. The database stores external information associated with the multimedia file, wherein the storage information is analyzed by reference to the external information. That is, the analyzing result is derived by reference to the external information. The generating code may be executed automatically or in response to an instruction. If the generating code is able to be executed in response to an instruction, the computer program further comprises code for receiving the instruction.

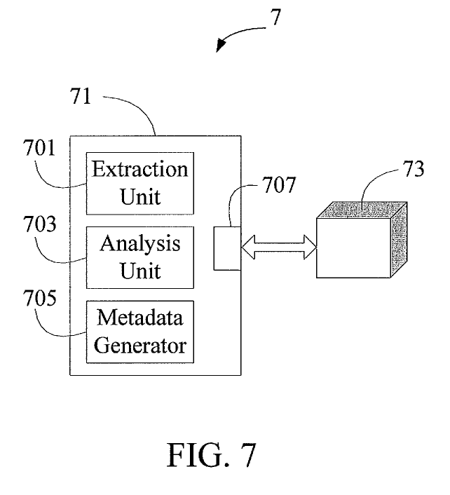

A tenth embodiment of this invention is illustrated in FIG. 7, which is a system 7 for generating and updating an ID3v2 for a MP3 file. The system 7 comprises a processing unit 71 and a storage device 73. The processing unit 71 comprises an extraction unit 701, an analysis unit 703, a metadata generator 705, and an interface 707, wherein the extraction unit 701 is similar to the extraction unit 201, the analysis unit 703 is similar to the analysis unit 202, and the metadata generator 705 is similar to the metadata generator 203. The storage device 73 is used to store multimedia file and connected to the processing unit 71 via the interface 707. It can be a floppy disk a hard disk an optical disc, a flash disk a tape, an Internet accessible database or any storage medium with a similar functionality. The extraction unit 701 extracts storage information of the multimedia file from the storage device 73. The analysis unit 703 analyzes the storage information. The metadata generator 705 generates the metadata according to an analyzing result. After the metadata is generated by the processing unit 71, the metadata is stored in the storage device 73 or embedded to the multimedia file. If the metadata already exists in the multimedia file before the processing unit 71 operates, the existed metadata is overwritten with the generated metadata.

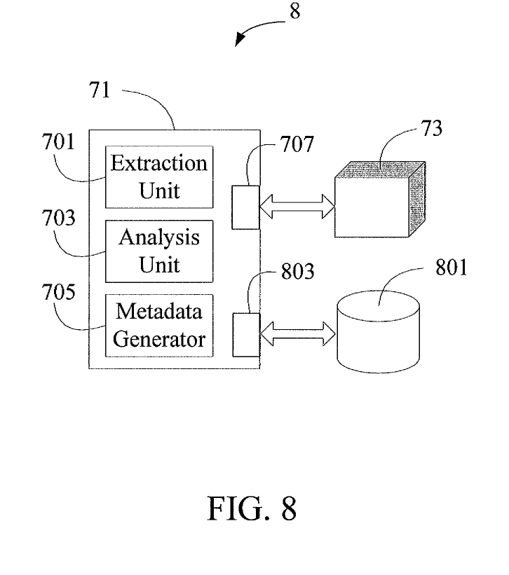

The eleventh embodiment of this invention is a system for generating a metadata for a multimedia file, which is illustrated in FIG. 8. In contrast with the tenth embodiment, the system 8 of the eleventh embodiment further a database 801 and the processing unit 71 further comprises an interface 803 for connecting to the database 801. After the metadata is generated, it is stored in the database 801 instead of stored in the storage device 73 or embedded to the multimedia file.

According to the aforementioned embodiments, the present invention is capable of generating and/or updating a metadata for a multimedia file based on data structure of the multimedia file. The items of the metadata are hence unnecessary to be inputted manually.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for generating a metadata embedded in a multimedia file, comprising the steps of:
extracting storage information of the multimedia file;
analyzing the storage information; and
generating the metadata according to an analyzing result.

2. The method of claim 1, wherein the storage information comprises a file name of the multimedia file.

3. The method of claim 1, wherein the storage information comprises a directory name associated with the multimedia file.

4. The method of claim 1, wherein the multimedia file is one of an audio, an image, a texture, and a video file.

5. The method of claim 1, wherein the storage information comprises one of a date, an artist, an album, and a title of the multimedia file, and a combination thereof.

6. The method of claim 1, wherein the storage information comprises names of a plurality of directories from a root directory to a subdirectory associated with the multimedia file.

7. The method of claim 1, wherein the analyzing step comprises the step of parsing one of a date, an artist, an album, and a title of the multimedia file, and a combination thereof.

8. The method of claim 1, further comprising the step of connecting to a database, the database storing external information associated with the multimedia file, wherein the storage information is analyzed by reference to the external information.

9. The method of claim 1, wherein the generating step is executed automatically.

10. The method of claim 1, further comprising the step of receiving an instruction, wherein the generating step is executed in response to the instruction.

11. A method for generating a metadata for a multimedia file, comprising the steps of:
extracting storage information of the multimedia file;
analyzing the storage information; and
generating the metadata according to an analyzing result;
wherein the metadata is stored in a first database.

12. The method of claim 11, wherein the storage information comprises a file name of the multimedia file.

13. The method of claim 11, wherein the storage information comprises a directory name associated with the multimedia file.

14. The method of claim 11, wherein the multimedia file is one of an audio, an image, a texture, and a video file.

15. The method of claim 11, wherein the storage information comprises one of a date, an artist, an album, and a title of the multimedia file, and a combination thereof.

16. The method of claim 11, wherein the storage information comprises names of a plurality of directories from a root directory to a subdirectory associated with the multimedia file.

17. The method of claim 11, wherein the analyzing step comprising the step of parsing one of a date, an artist, an album, and a title of the multimedia file, and a combination thereof.

18. The method of claim 11, further comprising the step of connecting to a second database, the second database storing external information associated with the multimedia file, wherein the storage information is analyzed by reference to the external information.

19. The method of claim 11, wherein the generating step is executed automatically.

20. The method of claim 11, further comprising the step of receiving an instruction, wherein the generating step is executed in response to the instruction.

21. A method for updating a metadata of a multimedia file, comprising the steps of:
extracting storage information of the multimedia file;
analyzing the storage information; and
updating the metadata according to an analyzing result.

22. The method of claim 21, wherein the metadata is embedded in the multimedia file.

23. The method of claim 21, wherein the metadata is stored in a database.

24. A computer program product for storing a computer program to execute a method for generating a metadata embedded in a multimedia file, the computer program comprising:
code for extracting storage information of the multimedia file;
code for analyzing the storage information; and
code for generating the metadata according to an analyzing result.

25. The computer program product of claim 24, wherein the storage information comprises a file name of the multimedia file.

26. The computer program product of claim 24, wherein the storage information comprises a directory name associated with the multimedia file.

27. The computer program product of claim 24, wherein the multimedia file is one of an audio, an image, a texture, and a video file.

28. The computer program product of claim 24, wherein the storage information comprises one of a date, an artist, an album, and a title of the multimedia file, and a combination thereof.

29. The computer program product of claim 24, wherein the storage information comprises names of a plurality of directories from a root directory to a subdirectory associated with the multimedia file.

30. The computer program product of claim 24, wherein the analyzing code comprises code for parsing one of a date, an artist, an album, and a title of the multimedia file, and a combination thereof.

31. The computer program product of claim 24, wherein the computer program further comprises code for accessing to a database, the database stores external information associated with the multimedia file, and the storage information is analyzed by reference to the external information.

32. The computer program product of claim 24, wherein the generating code is executed automatically.

33. The computer program product of claim 24, wherein the computer program further comprises code for receiving an instruction, and the generating code is executed in response to the instruction.

34. An apparatus for generating a metadata embedded in a multimedia file, comprising:
an extraction unit for extracting storage information of the multimedia file;
an analysis unit for analyzing the storage information; and
a metadata generator for generating the metadata according to an analyzing result.

35. The apparatus of claim 34, wherein the storage information comprises a file name of the multimedia file.

36. The apparatus of claim 34, wherein the storage information comprises a directory name associated with the multimedia file.

37. The apparatus of claim 34, wherein the multimedia file is one of an audio, an image, a texture, and a video file.

38. The apparatus of claim 34, wherein the storage information comprises one of a date, an artist, an album, and a title of the multimedia file, and a combination thereof.

39. The apparatus of claim 34, wherein the storage information comprises names of a plurality of directories from a root directory to a subdirectory associated with the multimedia file.

40. The apparatus of claim 34, wherein the analysis unit parses one of a date, an artist, an album, and a title of the multimedia file, and a combination thereof.

41. The apparatus of claim 34, further comprising an interface for connecting to a database, the database storing external information associated with the multimedia file, wherein the analysis unit analyzes the storage information by reference to the external information.

42. The apparatus of claim 34, wherein the metadata generator generates the metadata automatically.

43. The apparatus of claim 34, further comprising a user interface, wherein the metadata generator generates the metadata when receiving an instruction.

44. An apparatus for generating a metadata for a multimedia file, comprising:
an extraction unit for extracting storage information of the multimedia file;
an analysis unit for analyzing the storage information; and
a metadata generator for generating the metadata according to an analyzing result;
wherein the metadata is stored in a first database.

45. The apparatus of claim 44, wherein the storage information comprises a file name of the multimedia file.

46. The apparatus of claim 44, wherein the storage information comprises a directory name associated with the multimedia file.

47. The apparatus of claim 44, wherein the multimedia file is one of an audio, an image, a texture, and a video file.

48. The apparatus of claim 44, wherein the storage information comprises one of a date, an artist, an album, and a title of the multimedia file, and a combination thereof.

49. The apparatus of claim 44, wherein the storage information comprises names of a plurality of directories from a root directory to a subdirectory associated with the multimedia file.

50. The apparatus of claim 44, wherein the analysis unit parses one of a date, an artist, an album, and a title of the multimedia file, and a combination thereof.

51. The apparatus of claim 44, further comprising an interface for connecting to a second database, the second database storing external information associated with the multimedia file, wherein the analysis unit analyzes the storage information by reference to the external information.

52. The apparatus of claim 44, wherein the metadata generator generates the metadata automatically.

53. The apparatus of claim 44, further comprising a user interface, wherein the metadata generator generates the metadata when receiving an instruction.

54. An apparatus for updating a metadata of a multimedia file, comprising:
an extraction unit for extracting storage information of the multimedia file;
an analysis unit for analyzing the storage information; and
a metadata generator for updating the metadata according to an analyzing result.

55. The apparatus of claim 54, wherein the metadata is embedded in the multimedia file.

56. The apparatus of claim 54, wherein the metadata is stored in a database.

57. A system for generating a metadata embedded in a multimedia file, comprising:
a storage device for storing the multimedia file; and
a processing unit for extracting storage information of the multimedia file from the storage device, analyzing the storage information, and generating the metadata according to an analyzing result;
wherein the metadata is stored in the storage device.

58. A system for generating a metadata for a multimedia file, comprising:
a storage device for storing the multimedia file;
a processing unit for extracting storage information of the multimedia file from the storage device, analyzing the storage information, and generating the metadata according to an analyzing result; and
a database for storing the metadata.

59. A system for updating a metadata of a multimedia file, comprising:
a storage device for storing the metadata and the multimedia file; and
a processing unit for extracting storage information of the multimedia file from the storage device, analyzing the storage information, and generating a new metadata according to an analyzing result;
wherein the metadata is overwritten with the new metadata.

60. An apparatus for generating a metadata embedded in a multimedia file, comprising:
means for extracting storage information of the multimedia file;
means for analyzing the storage information; and
means for generating the metadata according to an analyzing result.

61. An apparatus for generating a metadata for a multimedia file, comprising:
means for extracting storage information of the multimedia file;
means for analyzing the storage information; and
means for generating the metadata according to an analyzing result;
wherein the metadata is stored in a database.

62. An apparatus for updating a metadata of a multimedia file, comprising:
means for extracting storage information of the multimedia file;
means for analyzing the storage information; and
means for updating the metadata according to an analyzing result.
